(19) United States
(12) Patent Application Publication
(10) Pub. No.: US 2026/0280635 A1
(43) Pub. Date: Sep. 17, 2026

(54) UNIFORM QUANTIZATION FOR CHANNEL STATE INFORMATION (CSI) FEEDBACK

(71) Applicant: QUALCOMM Incorporated, San Diego, CA (US)

(72) Inventors: Pinar SEN, San Diego, CA (US); Wei Yang, San Diego, CA (US); Mahmoud TAHERZADEH BOROUJENI, San Diego, CA (US)

(21) Appl. No.: 19/079,321

(22) Filed: Mar. 13, 2025

(51) Int. Cl. H04B 7/06; H04W 24/10; H04W 72/21

(52) U.S. Cl. CPC H04B 7/0626; H04W 24/10; H04W 72/21

(57) ABSTRACT

Techniques described herein may improve channel state information (CSI) feedback efficiency by uniformly quantizing time-domain channel taps based on quantization parameters to generate quantized channel tap information, followed by compression of the quantized channel tap information through separate or joint source channel coding. A user equipment (UE) may transmit the compressed quantized channel tap information as part of CSI feedback to a base station (BS).

### BACKGROUND

### Field of the Disclosure

Aspects of the present disclosure relate to wireless communications, and more particularly, to techniques for managing channel state information (CSI) feedback.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving signaling explicitly or implicitly configuring the UE with a set of quantization points. The method further includes transmitting quantized channel tap information as channel state information (CSI) feedback, wherein the quantized channel tap information comprises quantizing using the set of quantization points and coding of each channel tap of a wireless communication channel.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network, in accordance with certain aspects of the present disclosure.

FIG. 2 depicts an example disaggregated base station (BS) architecture, in accordance with certain aspects of the present disclosure.

FIG. 3 depicts aspects of an example BS and an example user equipment (UE), in accordance with certain aspects of the present disclosure.

FIG. 4A, FIG. 4B, FIG. 4C, and FIG. 4D depict various example aspects of data structures for a wireless communications network, in accordance with certain aspects of the present disclosure.

FIG. 5 depicts a call flow diagram illustrating example communication among a UE and a network entity for managing channel state information (CSI) feedback, in accordance with certain aspects of the present disclosure.

FIG. 6A depicts example quantization of channel tap information, in accordance with certain aspects of the present disclosure.

FIG. 6B depicts example quantization and joint source channel coding (JSCC) of channel tap information, in accordance with certain aspects of the present disclosure.

FIG. 6C depicts example quantization and separate source channel coding (SSCC) of channel tap information, in accordance with certain aspects of the present disclosure.

FIG. 7 depicts a method for wireless communications at a wireless node for managing CSI feedback, in accordance with certain aspects of the present disclosure.

FIG. 8 depicts example wireless node for managing CSI feedback, in accordance with certain aspects of the present disclosure.

### DETAILED DESCRIPTION

A channel tap may refer to a discrete representation of channel response to a transmitted signal. In wireless communication, a signal may undergo various changes as the signal travels from a transmitter to a receiver, including reflection, diffraction, and scattering. Such changes may be captured in the form of channel taps, which represent different delays and/or strengths of various paths the signal takes from the transmitter to the receiver.

Channel state information (CSI) may refer to channel information that describes a wireless channel between the transmitter and receiver, capturing how the channel affects the signal. The CSI may include information about the channel taps for each frequency subcarrier, which allows the receiver to understand how each signal path behaves. The CSI may provide information about the channel behavior, including amplitude and phase of each channel tap at different subcarriers, which may be used to model the channel response.

Precoding matrix indicator (PMI) information may be part of CSI feedback that is transmitted in an uplink message from a user equipment (UE) to a gNodeB (gNB). Some enhancements for the PMI information encoding have been introduced to support more resolution. However, supporting higher-resolution PMI information may require a larger payload size of the CSI feedback (e.g., in terms of number of bits). Also, all of the PMI information may be sent as one code block. So, if the CSI feedback transmission including the PMI information fails, the entire PMI information is lost.

Full channel matrix feedback may be better for optimizing a throughput in downlink multi-user multiple input-multiple output (MU-MIMO) systems because the full channel matrix feedback may provide detailed CSI, and thereby allowing for more precise beamforming and interference management. However, the full channel matrix feedback requires a larger feedback payload size, which can be a challenge in practical implementations due to bandwidth constraints.

In wireless network, uplink coverage may be weaker than downlink coverage due to transmission power differences between the UE and the gNB. Therefore, in many scenarios, a high-resolution CSI feedback (e.g., in the form of the PMI information feedback or the full channel matrix feedback) may be beneficial, but a large feedback payload that is needed for transmitting the high-resolution CSI feedback may face uplink coverage issues and/or require a huge amount of uplink resources.

Techniques described herein provide an efficient way of generating and conveying CSI feedback with less vulnerability to total information loss, while maintaining a minimum level of resolution. For example, the techniques described herein may improve CSI feedback efficiency by uniformly quantizing time-domain channel taps based on quantization parameters to generate quantized channel tap information, followed by compression of the quantized channel tap information through separate or joint source channel coding. The UE may then transmit the compressed quantized channel tap information as the CSI feedback to the gNB.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

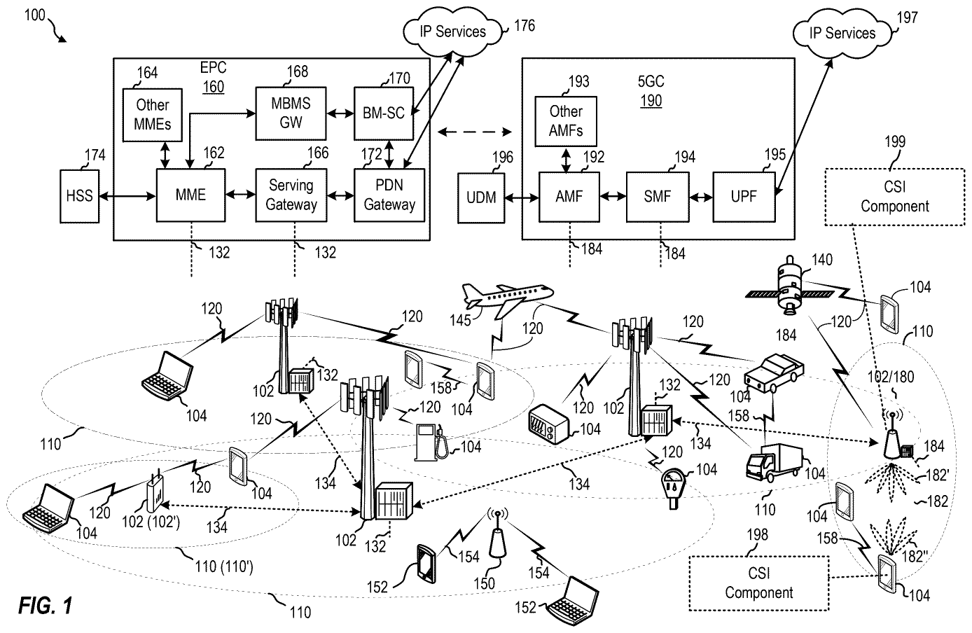

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others. UEs 104 may operate as relay devices.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

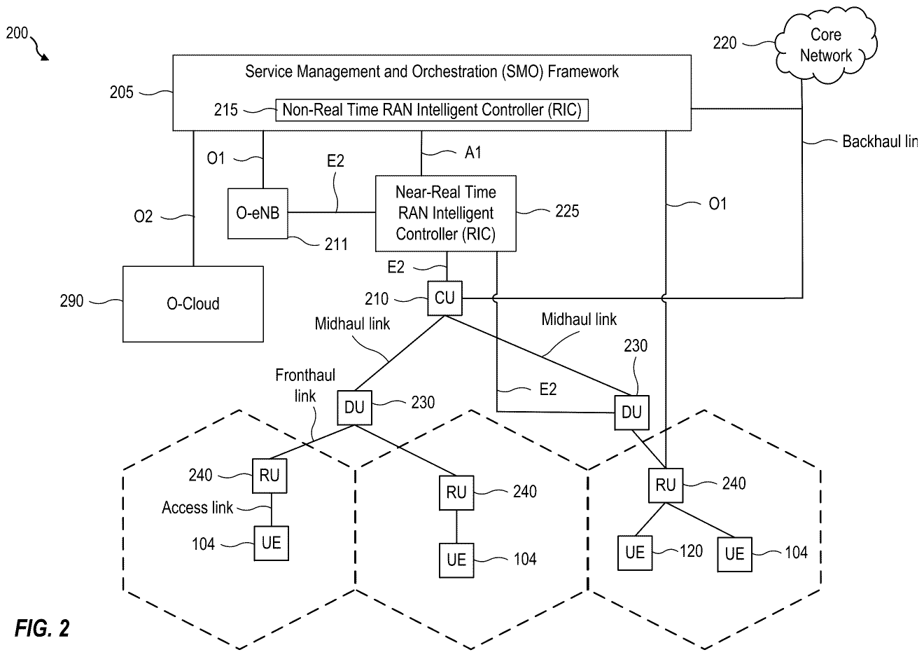

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 130) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

Wireless communication network 100 further includes channel state information (CSI) component 198, which may be configured to perform method 900 of FIG. 9. Wireless communication network 100 further includes CSI component 199, which may be configured to perform method 900 of FIG. 9.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

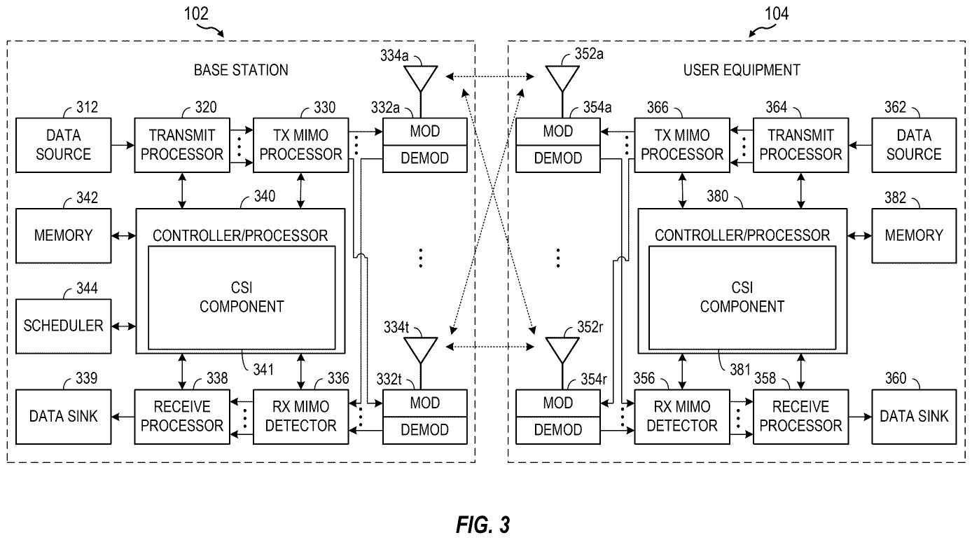

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes CSI component 341, which may be representative of CSI component 199 of FIG. 1. Notably, while depicted as an aspect of controller/processor 340, CSI component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes CSI component 381, which may be representative of CSI component 198 of FIG. 1. Notably, while depicted as an aspect of controller/processor 380, CSI component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

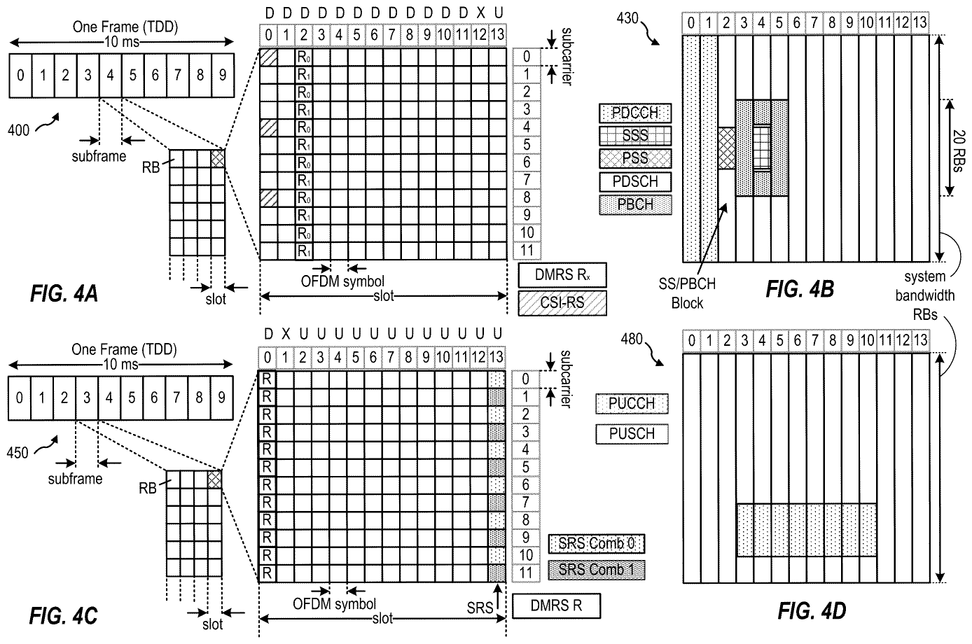

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR 1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Channel State Information (CSI)

Channel state information (CSI) refers to the knowledge of the properties of a communication channel in a wireless system. The CSI characterizes how signals propagate between a transmitter and a receiver, including path loss, fading, interference, and phase shift. Accurate CSI is critical for optimizing the wireless system performance by enabling adaptive transmission strategies.

The CSI is estimated at the receiver and then fed back to the transmitter. For example, CSI feedback refers to the process of sending the CSI from the receiver to the transmitter in the wireless system. The CSI feedback helps the transmitter optimize transmission parameters such as beamforming, power control, and modulation schemes based on channel conditions between the transmitter and the receiver.

The CSI may be crucial for improving signal quality (e.g., helps mitigate channel impairments such as fading and interference), efficient resource allocation (e.g., used in power control, beamforming, and spatial multiplexing in multiple input multiple output (MIMO) systems), adaptive modulation and coding (e.g., allows dynamic adjustment of modulation schemes and coding rates based on channel quality), and massive MIMO applications (e.g., essential for multi-antenna systems to enhance throughput and coverage).

There are different types of the CSI. Instantaneous CSI may provide real-time knowledge of a channel, which helps in immediate adjustments. Statistical CSI may provide long-term average characteristics of the channel, useful for network planning.

The CSI may be obtained through channel estimation techniques, which involve sending known signals (pilots) and analyzing the received signal response. The receiver uses these pilots to estimate channel coefficients.

For closed-loop MIMO and beamforming applications, the CSI needs to be sent back to the transmitter. This feedback may be quantized (compressed) CSI (e.g., limited number of bits are used to report the CSI), full CSI (e.g., requires high bandwidth but provides better accuracy), and differential CSI (e.g., only changes in the CSI are reported to reduce overhead).

In massive MIMO, advanced CSI compression and prediction techniques (e.g., machine learning-based CSI feedback) may be used to handle a large amount of CSI data.

### Overview of Channel Taps

In wireless communication, a channel tap represents an impulse response of a multipath channel at a specific time delay. It corresponds to a discrete-time representation of how different paths contribute to a received signal. Each tap captures the effect of a specific multipath component, including its attenuation, phase shift, and delay.

In high-frequency bands and complex propagation environments, signals may often experience multipath fading, where different reflected, scattered, and diffracted signal components arrive at different times. The channel taps may help model these effects in time-domain channel impulse response (CIR).

The channel taps may represent different multipath components in a wireless channel. The channel taps may be used to model how a signal propagates and how multipath affects the received signal.

### Overview of Channel Coding

Coding or channel coding, also known as error control coding, is a technique used in digital communication systems to detect and correct errors that occur during data transmission over a noisy channel. The primary goal of channel coding is to improve the reliability of a data transmission by adding redundancy to a transmitted signal.

A channel coding system consists of encoding at a transmitter, transmission through a channel, and decoding at a receiver. For example, an original message (data bits) may be passed through a channel encoder, which adds redundant bits. The encoded message is then sent through the channel. The encoded message propagates through the channel, where it may get distorted due to noise, interference, or fading. The receiver uses a channel decoder to analyze received bits and detect/correct errors.

### Example Channel Coding Approaches

Separate source channel coding (SSCC) refers to an approach in digital communication where source coding (compression) and channel coding (error correction) are designed independently. This approach is based on Shannon's separation theorem, which states that under ideal conditions (i.e., infinite block length and capacity-achieving codes), optimal transmission can be achieved by separately designing source and channel coding.

The source coding (compression) removes redundancy from source data to reduce a number of bits needed for transmission. Examples may include lossless compression (e.g., Huffman coding, arithmetic coding) and lossy compression (e.g., joint photographic experts group (for images), H.264 (for video)).

The channel coding (error correction) adds redundancy to compressed data to protect it against errors during transmission. Examples may include block codes (e.g., hamming codes, Reed-Solomon codes) and convolutional codes (e.g., turbo codes).

The compressed and encoded data is sent through the channel. A channel decoder at a receiver corrects errors using redundant bits. A source decoder reconstructs original data from a compressed version.

Joint source channel coding (JSCC) refers to an approach that combines source coding (compression) and channel coding (error protection) into a unified framework, rather than treating them separately. The goal is to maximize the end-to-end communication efficiency by jointly optimizing how information is compressed and how errors are corrected over noisy channels.

JSCC may be useful in several cases such as wireless and mobile networks (e.g., where bandwidth and power constraints are significant), real-time multimedia (e.g., applications that require low-latency transmission, like video conferencing and augmented reality), deep space communication (e.g., where retransmissions are costly due to high delays), and machine learning and semantic communication (e.g., where information relevance matters more than exact bit accuracy).

By jointly designing compression and error protection, the JSCC may achieve graceful degradation (e.g., even under bad channel conditions, information is still partially recoverable), better robustness (e.g., works well in highly dynamic and lossy channels) and reduced complexity (e.g., avoids the need for strict separation between source and channel coding).

### Aspects Related to Uniform Quantization for CSI Feedback for SSCC or JSCC

In new radio (NR), time division duplex (TDD) is one of the communication modes used. In the TDD, a same frequency band may be used for both uplink (UL) and downlink (DL) operations, but they occur at different time intervals.

Channel state information (CSI) is a feedback that a receiver (e.g., a user equipment (UE)) provides to a transmitter (e.g., a gNodeB (gNB)) to describe quality and characteristics of a communication channel. This helps the transmitter make informed decisions, like optimizing beamforming or precoding to improve signal quality.

Precoding matrix indicator (PMI) is one element of the CSI that may help the gNB determine an optimal precoding matrix to use for a transmission. Precoding is a technique used to adapt the transmission to channel conditions (e.g., using multiple input multiple output (MIMO) techniques for multiple antenna systems).

The PMI may be part of CSI feedback the UE sends to the gNB. The CSI feedback may be transmitted using two types of channels: a physical uplink control channel (PUCCH) and a physical uplink shared channel (PUSCH). The PUCCH may be used for sending small amounts of control information from the UE to the gNB. The PUSCH may be used for larger amounts of data transmission in the uplink.

Release 16 of 5G introduced enhancements to encoding of the PMI to allow for higher resolution. This means that the CSI feedback can represent the channel more accurately, which is beneficial for optimizing the transmission (e.g., in MIMO or beamforming). The higher resolution of the PMI may also allow the gNB to better understand the channel state and select the best precoding strategy.

The higher resolution of the PMI may also mean more detailed PMI information, and to represent this increased detail, a larger payload (i.e., more bits) is required.

All the PMI information is transmitted as a single code block. In error control coding, a code block is a set of data that is transmitted together and protected by error correction mechanisms (e.g., forward error correction).

If there is an error in the transmission of this code block, the entire PMI information can be lost, since the whole block is treated as a single unit. In other words, a single error in any part of the code block can result in the complete loss of the PMI information, which means the gNB won't have the necessary information to optimize its precoding.

In a multi-user MIMO system, the CSI may be crucial for optimizing data transmission. If a full channel matrix is fed back from the UE to the gNB, the CSI provides more accurate and detailed information about the wireless channel. This can help the gNB optimize beamforming and resource allocation, leading to better throughput in the downlink.

The PMI is a compressed form of feedback, where the UE selects a precoding matrix from a predefined codebook and sends back an index representing the best matrix. PMI feedback requires less bandwidth but is less accurate compared to full channel matrix feedback.

The full channel matrix feedback requires the UE to send a large amount of data back to the gNB, significantly increasing the feedback overhead (i.e., a payload size). The PMI feedback, being a more compact representation, results in a smaller payload size.

In cellular wireless network, the gNB has significantly higher transmission power (e.g., tens of watts), whereas the UE operates at much lower power (e.g., a few hundred mill watts). This results in the uplink signal experiencing greater path loss, leading to weaker coverage and a lower signal-to-noise ratio (SNR) in the uplink. The impact is that even if the UE can receive strong downlink signals, it might struggle to send back data effectively in the uplink.

The CSI is crucial for optimizing beamforming and multi-user MIMO in the downlink. The higher the resolution (e.g., the full channel matrix vs. the PMI), the better the gNB can optimize downlink transmissions. However, a high-resolution CSI feedback requires large amounts of data to be transmitted from the UE to the gNB in the uplink. Due to weaker uplink link budget, transmitting a large CSI feedback payload may lead to uplink coverage issues. For example, some UEs at a cell edge or in weak uplink conditions might not be able to send the CSI feedback reliably. The transmission of the large CSI feedback payload may also require high resource consumption. For example, the large CSI feedback payload may take up a significant portion of uplink resources, and thereby reducing an available bandwidth for other uplink transmissions like user data or control signaling.

Techniques described herein provide an efficient way of generating and conveying CSI feedback with less vulnerability to total information loss, while maintaining a minimum level of resolution. For instance, the techniques described herein may balance the CSI feedback accuracy and uplink resource efficiency by using compressed CSI feedback or selectively enabling high-resolution CSI feedback.

In some examples, the techniques described herein may improve CSI feedback efficiency by uniformly quantizing dominant time-domain channel taps based on consistent quantization parameters to generate quantized channel tap information, followed by compression of the quantized channel tap information through separate or joint source channel coding. The UE may then transmit the compressed quantized channel tap information as part of the CSI feedback to the gNB.

A channel tap may refer to an individual multipath component of a wireless communication channel. When a signal is transmitted in a wireless environment, the signal usually doesn't travel in a straight line from a transmitter to a receiver. Instead, the signal undergoes reflections, scattering, and diffraction due to objects in the environment (e.g., buildings, trees, and other obstacles). Each of these different propagation paths is associated with a time delay, amplitude (gain), and phase. The set of these delayed, attenuated, and phase-shifted copies of the transmitted signal forms channel taps.

A channel may be described as a combination of the channel taps, each contributing to an overall received signal. For example, the channel may be represented as a series of channel taps corresponding to different delays (or time slots). The channel with N number of channel taps may mean that the signal has N significant multipath components, each contributing to the received signal in terms of delay, amplitude, and/or phase.

In 3^{rd} Generation Partnership Project (3GPP) standards related to CSI feedback, a channel tap refers to a single discrete time delay component within a channel's impulse response, representing signal's strength at a specific delay, essentially capturing the effect of a single propagation path between a transmitter and a receiver.

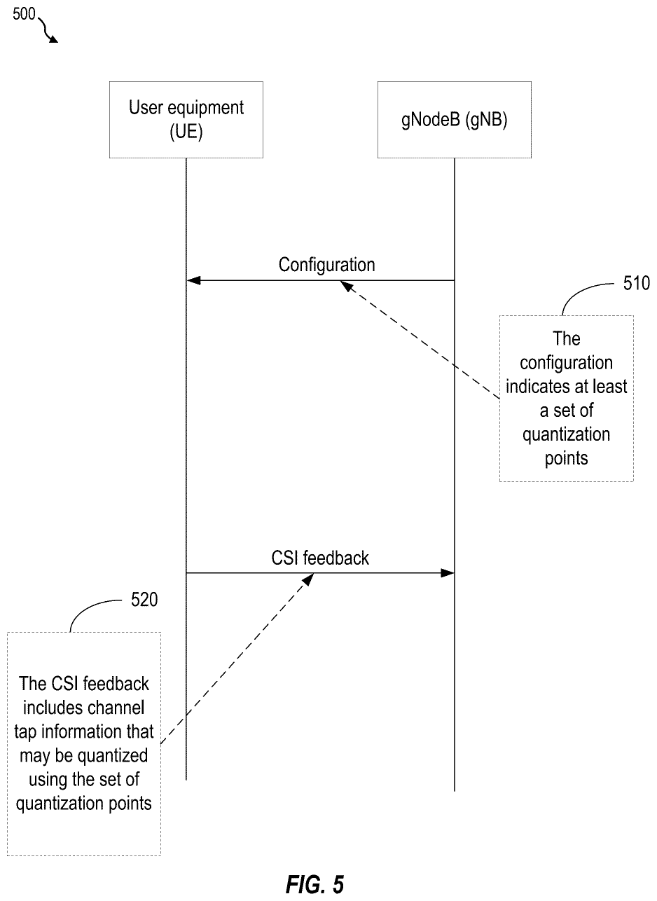

The techniques proposed herein may be further understood with reference to FIG. 5-FIG. 8.

FIG. 5 depicts a call flow diagram 500 illustrating example communication among a UE and a network entity (e.g., a gNB) for managing CSI feedback. The UE shown in FIG. 5 may be an example of the UE 104 depicted and described with respect to FIG. 1 and FIG. 3. The gNB depicted in FIG. 5 may be an example of the BS 102 depicted and described with respect to FIG. 1 and FIG. 3, or the disaggregated BS depicted and described with respect to FIG. 2.

As indicated at 510, the gNB sends signaling carrying a configuration indicating a set of quantization points to the UE. The set of quantization points may include uniformly spaced quantization points.

As indicated at 520, the UE transmits CSI feedback (e.g., in a CSI report) to the gNB. The CSI feedback may include channel tap information for a number of channel taps. The channel tap information may be quantized based on the set of quantization points.

In certain aspects, the UE may quantize each channel tap of the number of channel taps to a (closest) quantization point from the set of quantization points to generate the quantized channel tap information. For example, uniform quantization of the channel tap information may be performed by quantizing a continuous source (i.e., channel taps) to a set of the uniformly spaced quantization points.

In certain aspects, the UE may generate the CSI feedback based on channel measurements obtained from processing of one or more CSI reference signals received from the gNB.

In one example, the UE may transmit the quantized channel tap information to the gNB via a PUCCH. In another example, the UE may transmit the quantized channel tap information to the gNB via a PUSCH.

In certain aspects, the gNB may send to the UE one or more quantization parameters that may be used for performing the uniform quantization of the channel tap information. A first quantization parameter may indicate a step size between adjacent quantization points of the set of quantization points. For example, the step size may indicate space between any two adjacent quantization points of the set of quantization points. A second quantization parameter may indicate a window defining boundaries of the set of quantization points. A third quantization parameter may indicate a quantity of the quantization points in the set of quantization points.

In one aspect, the gNB and the UE may exchange information with each other to agree on the set of quantization points, which may be configured by the gNB. For example, the gNB may directly configure the set of quantization points and the UE may use the configured set of quantization points for performing the uniform quantization of the channel tap information.

In another aspect, the UE may derive the set of quantization points from the quantization parameters. For example, the UE may derive the set of quantization points based on the step size between the adjacent quantization points, the window defining the boundaries of the set of quantization points and/or the quantity of the quantization points in the set of quantization points. The UE may use the derived set of quantization points for performing the uniform quantization of the channel tap information.

In certain aspects, the quantized channel tap information may be provided for a configurable number of channel taps. For example, for multiple input multiple output (MIMO) systems, the UE may quantize dominant time domain channel taps of a channel with the gNB and a number of channel taps may be configurable by the gNB.

In certain aspects, the set of quantization points may be used to separately quantize in-phase (I) and quadrature (Q) components of the quantized channel tap information. For example, the quantization may be performed on I/Q separately (e.g., instead of phase/amplitude quantization).

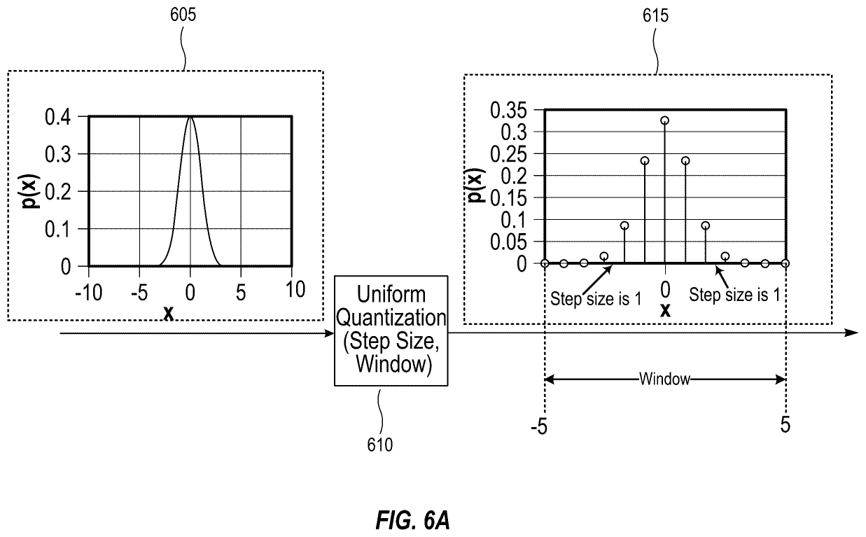

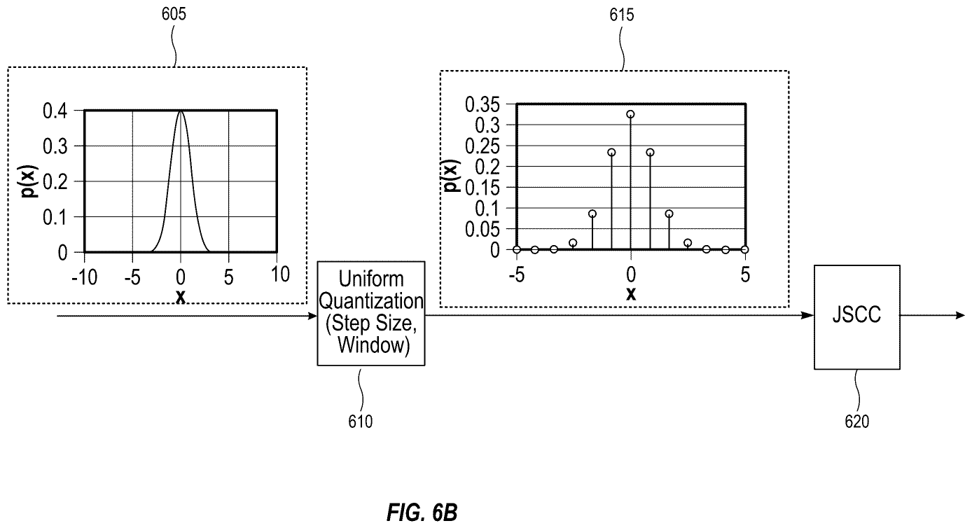

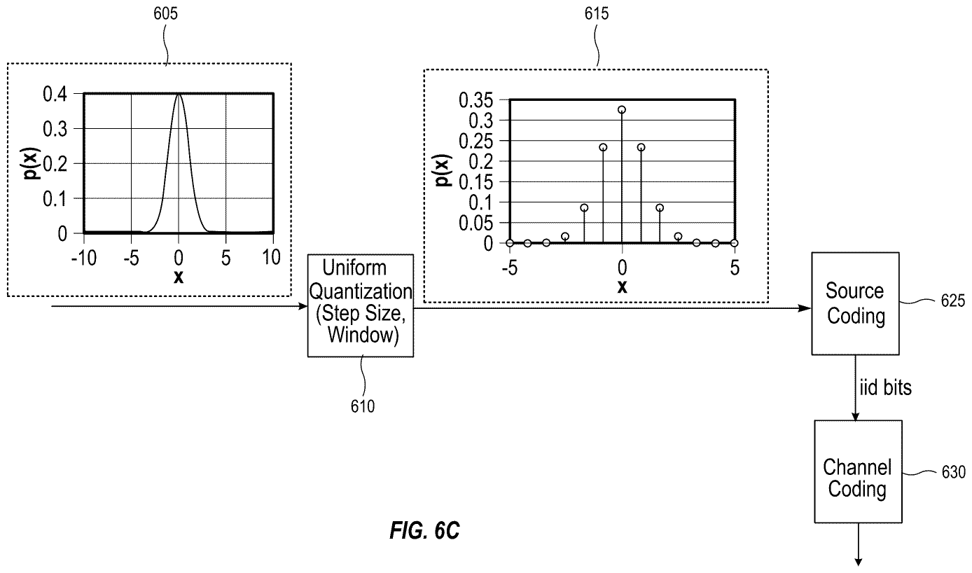

FIG. 6A depicts uniform quantization of channel tap information. For example, the UE may generate or determine the channel tap information (e.g., which may be represented by 605 where x signifies channel taps and p(x) signifies distribution of channel taps). The channel tap information may indicate continuous source (channel taps). The UE performs the uniform quantization of the channel tap information (at 610) based one or more quantization parameters. One quantization parameter may indicate a step size indicating the space between two adjacent quantization points. Another quantization parameter may indicate a window defining boundaries of quantization points (e.g., −5 to +5). Another quantization parameter may indicate a quantity of the quantization points. The UE generates the quantized channel tap information (represented by 615) based on the quantization parameters. The quantized channel tap information may indicate a set of uniformly spaced quantization points.

In certain aspects, coding or channel coding may include source and channel coding. The source and channel coding may be used to compress the quantized channel tap information after quantization using the set of quantization points. For example, the UE may apply a same uniform quantizer across different channel taps to generate the quantized channel tap information, and then perform compression (e.g., based on joint source channel coding (JSCC) (e.g., represented by 620 in FIG. 6B) or separate source channel coding (SSCC) (e.g., represented by 625, 630 in FIG. 6C)) after quantization to compress a payload of the quantized channel tap information.

In certain aspects, the UE may map quantized samples of the quantized channel tap information, corresponding to the set of quantization points, to binary sequences. The UE may then encode the binary sequences in accordance with the JSCC. For example, the UE may map each sample to a K-bit binary sequence where K is greater than or equal to log 2 (e.g., a number of quantized samples). This may be to convey a K-bit message (as CSI feedback) corresponding to a channel tap realization.

In certain aspects, the gNB may indicate a type of the coding or channel coding to be used to the UE. For example, the gNB and the UE may exchange information with each other to agree on the JSCC technique to be used by the UE to compress the quantized channel tap information.

In certain aspects, the gNB may also indicate a channel tap power to the UE. The channel tap power may refer to a signal power associated with each individual channel tap. Since different paths or channel taps may have different lengths and environmental characteristics, signal strength (power) at each channel tap varies. Some paths may have higher power due to short distances or direct line-of-sight, while others may have lower power due to attenuation over longer distances or through obstacles. The channel tap power may be expressed as the power associated with each channel tap. For example, a direct line-of-sight path may have a higher channel tap power compared to a reflected path that travels a longer distance and undergoes attenuation. The total received signal power is the sum of the powers of all the individual taps. The UE may derive a probability distribution of the quantized channel tap information based on the quantization parameters and/or the channel tap power.

In certain aspects, the UE may compress the quantized channel tap information using the SSCC to generate compressed quantized channel tap information. For example, after the uniform quantization of the channel tap information, the quantized samples of the quantized channel tap information may have a non-uniform distribution. The UE may apply source coding (e.g., Huffman coding, arithmetic coding, etc.) to map the quantized samples of the quantized channel tap information to independent and identically distributed (IID) bits, and then transmit the IID bits with a regular PUCCH and/or PUSCH.

The IID bits may be a series of bits that are independently and identically distributed, meaning each bit is generated randomly, with no relation to the others, and each has a same probability distribution (e.g., a 50% chance of being 0 or 1).

In certain aspects, the UE may provide or send the compressed quantized channel tap information via a medium access control (MAC) control element (CE). The UE may indicate, via a header in the MAC CE, a payload size for the compressed quantized channel tap information. For example, the source coding may end up with a variable length of message bits (e.g., the IID bits). The payload size may then be variable, and the payload size may be indicated to the gNB via the MAC-CE. So, when the CSI report is transmitted in the MAC CE, then the MAC CE may have the header that may indicate the payload size, and subsequent IID bits being the payload.

In certain aspects, the source coding information (e.g., such as Huffman coding, arithmetic coding, etc.) may be known to both the UE and the gNB.

In certain aspects, for the JSCC and the SCCC, the non-uniform distribution of the uniformly quantized samples of the quantized channel tap information may need to be known/derived at the UE and the gNB. The distribution of the uniformly quantized samples may be derived using the channel tap power and/or the quantization parameters such as the step size between the adjacent quantization points, the window defining the boundaries of the set of quantization points and/or the quantity of the quantization points in the set of quantization points. The quantization parameters may be configured using a radio resource control (RRC) depending on a largest channel tap.

In certain aspects, the channel taps may be grouped in the CSI report based on signal strength and/or power. For example, strong channel taps may be grouped together in the CSI report.

In certain aspects, the channel taps may be grouped in the CSI report based on correlation across the channel taps. For example, instead of transmitting separate messages for each channel tap in the CSI report, the UE may transmit few channel taps and some delta difference in the CSI report. For example, the UE may send the CSI report including an index of top k number of channel taps, an absolute value for a top channel tap (e.g., a first largest channel tap), and differential of other top channel taps (e.g., 2^{nd} to k^{th} channel taps) in reference to the top channel tap.

### Example Method for Wireless Communications at a Wireless Node

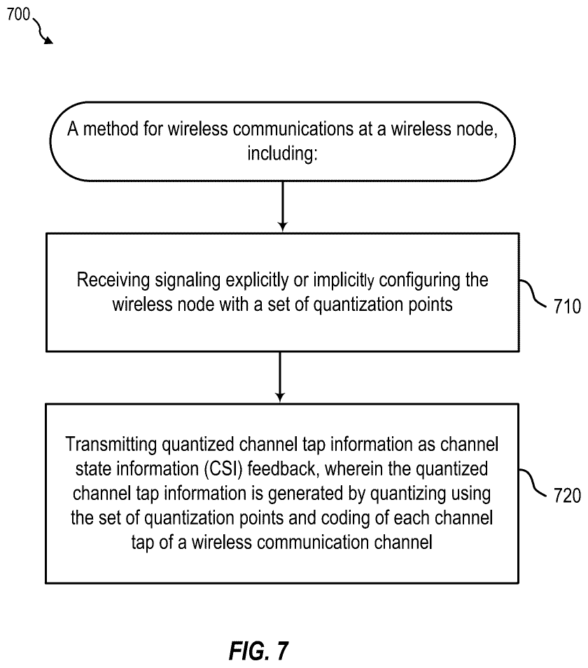

FIG. 7 shows an example of a method 700 for wireless communications at a wireless node. The wireless node may be a user equipment (UE), such as the UE 104 of FIG. 1 and FIG. 3.

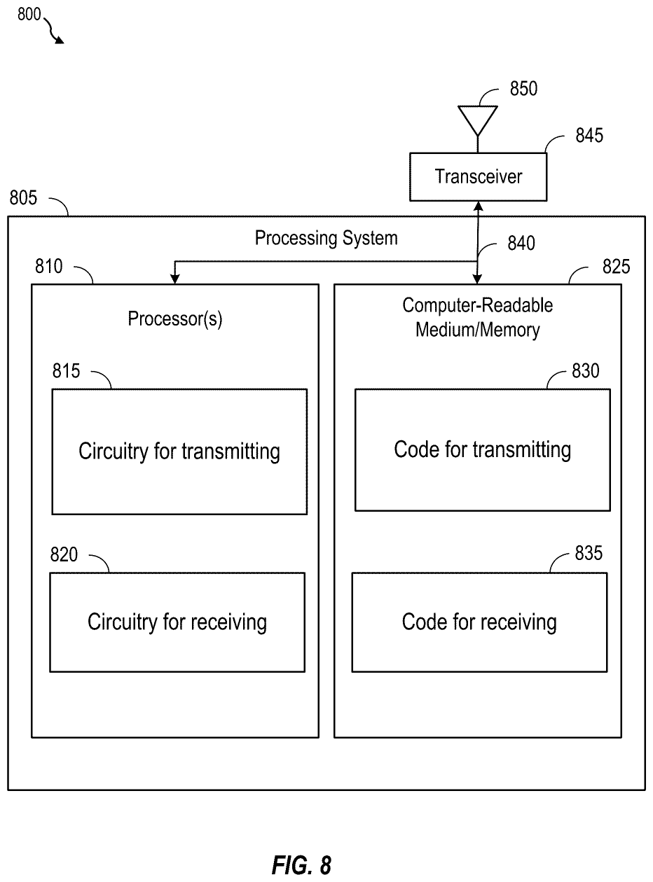

Method 700 begins at 710 with receiving signaling explicitly or implicitly configuring the UE with a set of quantization points. In some cases, the operations of this step refer to, or may be performed by, circuitry for receiving and/or code for receiving as described with reference to FIG. 8.

Method 700 then proceeds to 720 with transmitting quantized channel tap information as channel state information (CSI) feedback, wherein the quantized channel tap information is generated by quantizing using the set of quantization points and coding of each channel tap of a wireless communication channel. In some cases, the operations of this step refer to, or may be performed by, circuitry for transmitting and/or code for transmitting as described with reference to FIG. 8.

In certain aspects, the each channel tap corresponds to an individual multipath component of the wireless communication channel and the quantized channel tap information may be transmitted via at least one of a physical uplink control channel (PUCCH) or a physical uplink shared channel (PUSCH).

In certain aspects, the set of quantization points may include uniformly spaced quantization points. In certain aspects, the method 900 further includes quantizing the each channel tap to a quantization point from the set of quantization points.

In certain aspects, the signaling explicitly may indicate the set of quantization points.

In certain aspects, the signaling may indicate quantization parameters including at least two of: a step size between adjacent quantization points, a window defining boundaries of the set of quantization points, or a quantity of the quantization points in the set of quantization points. In certain aspects, the method 900 further includes deriving the set of quantization points from the quantization parameters.

In certain aspects, the quantized channel tap information may be provided for a configurable number of channel taps.

In certain aspects, the set of quantization points may be used to separately quantize in-phase (I) and quadrature (Q) components of the quantized channel tap information.

In certain aspects, the coding may include source and channel coding, and the source and channel coding may be used to communicate the quantized channel tap information after quantization using the set of quantization points.

In certain aspects, the coding may include joint source channel coding (JSCC).

In certain aspects, the method 700 further includes mapping quantized samples, corresponding to the set of quantization points, to binary sequences. In certain aspects, the method 700 further includes encoding the binary sequences in accordance with the JSCC.

In certain aspects, the signaling may indicate at least one of: quantization parameters including at least two of: a step size between adjacent quantization points, a window defining boundaries of the set of quantization points, or a quantity of the quantization points in the set of quantization points; a type of the coding to be used; or a channel tap power referring to a signal power associated with each individual channel tap. In certain aspects, the method 700 further includes deriving a probability distribution of the quantized channel tap information based on the quantization parameters and the channel tap power.

In certain aspects, the coding may include separate source channel coding (SSCC).

In certain aspects, In certain aspects, the method 700 further includes compressing and communicating the quantized channel tap information using the SSCC. The compressed quantized channel tap information may be provided via a medium access control (MAC) control element (CE). The UE indicates, via a header in the MAC CE, a payload size for the compressed quantized channel tap information.

In certain aspects, the signaling may indicate a type of the SSCC to be used.

In certain aspects, the quantized channel tap information may be provided, via a CSI report, for a number of channel taps. In certain aspects, channel taps are grouped in the CSI report may be based on at least one of: signal strength or correlation across taps.

In one aspect, the method 700, or any aspect related to it, may be performed by an apparatus, such as a wireless node 800 of FIG. 8, which includes various components operable, configured, or adapted to perform the method 700. The wireless node 800 is described below in further detail.

Note that FIG. 7 is just one example of a method, and other methods including fewer, additional, or alternative steps are possible consistent with this disclosure.

### Example Wireless Node

FIG. 8 depicts aspects of an example wireless node 800. The wireless node 800 may be a user equipment (UE), such as UE 104 described above with respect to FIG. 1 and FIG. 3.

The wireless node 800 includes a processing system 805 coupled to a transceiver 845 (e.g., a transmitter and/or a receiver). The transceiver 845 is configured to transmit and receive signals for the wireless node 800 via an antenna 850, such as the various signals as described herein. The processing system 805 may be configured to perform processing functions for the wireless node 800, including processing signals received and/or to be transmitted by the wireless node 800.

The processing system 805 includes one or more processors 810. In various aspects, the one or more processors 810 may be representative of one or more of receive processor 358, transmit processor 364, TX MIMO processor 366, and/or controller/processor 380, as described with respect to FIG. 3. The one or more processors 810 are coupled to a computer-readable medium/memory 825 via a bus 840. In certain aspects, the computer-readable medium/memory 825 is configured to store instructions (e.g., computer-executable code) that when executed by the one or more processors 810, cause the one or more processors 810 to perform the method 700 described with respect to FIG. 7, and/or any aspect related to it. Note that reference to a processor performing a function of wireless node 800 may include the one or more processors 810 performing that function of wireless node 800.

In the depicted example, computer-readable medium/memory 825 stores code (e.g., executable instructions), such as code for transmitting 830 and code for receiving 835. Processing of the code for transmitting 830 and the code for receiving 835 may cause the wireless node 800 to perform the method 700 described with respect to FIG. 7, and/or any aspect related to it.

The one or more processors 810 include circuitry configured to implement (e.g., execute) the code stored in the computer-readable medium/memory 825, including circuitry such as circuitry for transmitting 815 and circuitry for receiving 820. Processing with the circuitry for transmitting 815 and the circuitry for receiving 820 may cause the wireless node 800 to perform the method 700 described with respect to FIG. 7, and/or any aspect related to it.

Various components of the wireless node 800 may provide means for performing the method 700 described with respect to FIG. 7, and/or any aspect related to it. For example, means for transmitting, sending or outputting (e.g., for transmission) may include transceivers 354 and/or antenna(s) 352 of the UE 104 illustrated in FIG. 3 and/or the code for transmitting 830, the circuitry for transmitting 815, the transceiver 845 and the antenna 850 of the wireless node 800 in FIG. 8. Means for receiving or obtaining may include transceivers 354 and/or antenna(s) 352 of the UE 104 illustrated in FIG. 3 and/or the code for receiving 835, the circuitry for receiving 820, the transceiver 845 and the antenna 850 of the wireless node 800 in FIG. 8.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive multiple-input and multiple-output (MIMO) processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 8 is an example, and many other examples and configurations of wireless node 800 are possible.

### Example Clauses

Implementation examples are described in the following numbered clauses:
Clause 1: A method for wireless communication at a user equipment (UE), comprising: receiving signaling explicitly or implicitly configuring the UE with a set of quantization points; and transmitting quantized channel tap information as channel state information (CSI) feedback, wherein the quantized channel tap information is generated by quantizing using the set of quantization points and coding of each channel tap of a wireless communication channel.
Clause 2: The method of clause 1, wherein the each channel tap corresponds to an individual multipath component of the wireless communication channel and the quantized channel tap information is transmitted via at least one of a physical uplink control channel (PUCCH) or a physical uplink shared channel (PUSCH).
Clause 3: The method of any one of clauses 1-2, wherein: the set of quantization points comprises uniformly spaced quantization points; quantizing the each channel tap to a quantization point from the set of quantization points; and the each channel tap corresponds to an individual multipath component of the wireless communication channel.
Clause 4: The method of clause 3, wherein the signaling explicitly indicates the set of quantization points.
Clause 5: The method of clause 3, wherein: the signaling indicates quantization parameters including at least two of: a step size between adjacent quantization points, a window defining boundaries of the set of quantization points, or a quantity of the quantization points in the set of quantization points; and the method further comprises deriving the set of quantization points from the quantization parameters.
Clause 6: The method of any one of clauses 1-5, wherein the quantized channel tap information is provided for a configurable number of channel taps.
Clause 7: The method of any one of clauses 1-6, wherein the set of quantization points are used to separately quantize in-phase (I) and quadrature (Q) components of the quantized channel tap information.
Clause 8: The method of any one of clauses 1-7, wherein: the coding comprises source and channel coding, and the source and channel coding is used to communicate the quantized channel tap information after quantization using the set of quantization points.
Clause 9: The method of clause 8, wherein the coding comprises joint source channel coding (JSCC).
Clause 10: The method of clause 9, further comprising: mapping quantized samples, corresponding to the set of quantization points, to binary sequences; and encoding the binary sequences in accordance with the JSCC.
Clause 11: The method of clause 8, wherein the signaling indicates at least one of: quantization parameters including at least two of: a step size between adjacent quantization points, a window defining boundaries of the set of quantization points, or a quantity of the quantization points in the set of quantization points; a type of the coding to be used; or a channel tap power referring to a signal power associated with each individual channel tap; and deriving a probability distribution of the quantized channel tap information based on the quantization parameters and the channel tap power.
Clause 12: The method of clause 8, wherein the coding comprises separate source channel coding (SSCC).
Clause 13: The method of clause 12, wherein: compressing and communicating the quantized channel tap information using the SSCC; the compressed quantized channel tap information is provided via a medium access control (MAC) control element (CE); and the UE indicates, via a header in the MAC CE, a payload size for the compressed quantized channel tap information.
Clause 14: The method of clause 12, wherein the signaling indicates a type of the SSCC to be used.
Clause 15: The method of any one of clauses 1-14, wherein: the quantized channel tap information is provided, via a CSI report, for a number of channel taps; and channel taps are grouped in the CSI report based on at least one of: signal strength or correlation across taps.
Clause 16: An apparatus, comprising: a memory comprising executable instructions; and one or more processors configured, individually or in any combination, to execute the executable instructions and cause the apparatus to perform a method in accordance with any one of Clauses 1-15.
Clause 17: An apparatus, comprising means for performing a method in accordance with any one of Clauses 1-15.
Clause 18: A non-transitory computer-readable medium comprising executable instructions that, when executed by one or more processors of an apparatus, cause the apparatus to perform a method in accordance with any one of Clauses 1-15.
Clause 19: A computer program product embodied on a computer-readable storage medium comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors, individually or collectively, configured to execute the instructions and cause the apparatus to:
receive signaling explicitly or implicitly configuring the UE with a set of quantization points; and
transmit quantized channel tap information as channel state information (CSI) feedback, wherein the quantized channel tap information is generated by quantizing using the set of quantization points and coding of each channel tap of a wireless communication channel.

2. The apparatus of claim 1, wherein:
the each channel tap corresponds to an individual multipath component of the wireless communication channel; and
the quantized channel tap information is transmitted via at least one of a physical uplink control channel (PUCCH) or a physical uplink shared channel (PUSCH).

3. The apparatus of claim 1, wherein:
the set of quantization points comprises uniformly spaced quantization points;
the one or more processors, individually or collectively, are configured to execute the instructions and cause the apparatus to quantize the each channel tap to a quantization point from the set of quantization points; and
the each channel tap corresponds to an individual multipath component of the wireless communication channel.

4. The apparatus of claim 3, wherein the signaling explicitly indicates the set of quantization points.

5. The apparatus of claim 3, wherein:
the signaling indicates quantization parameters including at least two of: a step size between adjacent quantization points, a window defining boundaries of the set of quantization points, or a quantity of the quantization points in the set of quantization points; and
the one or more processors, individually or collectively, are configured to execute the instructions and cause the apparatus to derive the set of quantization points from the quantization parameters.

6. The apparatus of claim 1, wherein the quantized channel tap information is provided for a configurable number of channel taps.

7. The apparatus of claim 1, wherein the set of quantization points are used to separately quantize in-phase (I) and quadrature (Q) components of the quantized channel tap information.

8. The apparatus of claim 1, wherein:
the coding comprises source and channel coding, and
the source and channel coding is used to communicate the quantized channel tap information after quantization using the set of quantization points.

9. The apparatus of claim 8, wherein the coding comprises joint source channel coding (JSCC).

10. The apparatus of claim 9, wherein the one or more processors, individually or collectively, are configured to execute the instructions and cause the apparatus to:
map quantized samples, corresponding to the set of quantization points, to binary sequences; and
encode the binary sequences in accordance with the JSCC.

11. The apparatus of claim 8, wherein
the signaling indicates at least one of:
quantization parameters including at least two of: a step size between adjacent quantization points, a window defining boundaries of the set of quantization points, or a quantity of the quantization points in the set of quantization points;
a type of the coding to be used; or
a channel tap power referring to a signal power associated with each individual channel tap; and
the one or more processors, individually or collectively, are configured to execute the instructions and cause the apparatus to derive a probability distribution of the quantized channel tap information based on the quantization parameters and the channel tap power.

12. The apparatus of claim 8, wherein the coding comprises separate source channel coding (SSCC).

13. The apparatus of claim 12, wherein:
the one or more processors, individually or collectively, are configured to execute the instructions and cause the apparatus to compress and communicate the quantized channel tap information using the SSCC;
the compressed quantized channel tap information is provided via a medium access control (MAC) control element (CE); and
the UE indicates, via a header in the MAC CE, a payload size for the compressed quantized channel tap information.

14. The apparatus of claim 12, wherein the signaling indicates a type of the SSCC to be used.

15. The apparatus of claim 1, wherein:
the quantized channel tap information is provided, via a CSI report, for a number of channel taps; and
channel taps are grouped in the CSI report based on at least one of: signal strength or correlation across taps.

16. A method for wireless communication at a user equipment (UE), comprising:
receiving signaling explicitly or implicitly configuring the UE with a set of quantization points; and
transmitting quantized channel tap information as channel state information (CSI) feedback, wherein the quantized channel tap information is generated by quantizing using the set of quantization points and coding of each channel tap of a wireless communication channel.

17. The method of claim 16, wherein:
the each channel tap corresponds to an individual multipath component of the wireless communication channel; and
the quantized channel tap information is transmitted via at least one of a physical uplink control channel (PUCCH) or a physical uplink shared channel (PUSCH).

18. The method of claim 16, wherein:
the set of quantization points comprises uniformly spaced quantization points;
quantizing each channel tap to a quantization point from the set of quantization points; and
the each channel tap corresponds to an individual multipath component of the wireless communication channel.

19. The method of claim 18, wherein the signaling explicitly indicates the set of quantization points.

20. A non-transitory computer-readable medium comprising instructions that, when executed by one or more processors of a user equipment (UE), cause the one or more processors to perform a method, comprising, comprising:
receiving signaling explicitly or implicitly configuring the UE with a set of quantization points; and
transmitting quantized channel tap information as channel state information (CSI) feedback, wherein the quantized channel tap information is generated by quantizing using the set of quantization points and coding of each channel tap of a wireless communication channel.
